(19) United States
(12) Patent Application Publication
(10) Pub. No.: US 2015/0356669 A1
(43) Pub. Date: Dec. 10, 2015

(54) DESIGNING NAIL WRAPS WITH AN ELECTRONIC DEVICE

(71) Applicant: MYNCLA MOBILE LLC, Los Angeles, CA (US)

(72) Inventors: Daniel Roescheisen, Los Angeles, CA (US); Rory Rockmore, New York, NY (US); Elin Dannerstedt, Los Angeles, CA (US)

(21) Appl. No.: 14/730,051

(22) Filed: Jun. 3, 2015

Related U.S. Application Data
(60) Provisional application No. 62/008,834, filed on Jun. 6, 2014.

(51) Int. Cl. G06Q 30/06; G06Q 10/02; A45D 29/00

(52) U.S. Cl. CPC G06Q 30/0643; A45D 29/001; G06Q 30/0639; G06Q 10/02

(57) ABSTRACT

A portable device that is able to capture images and provide the functionality for editing, scaling and/or cropping images such that a modified image is suitable to be reproduced on a nail wrap is disclosed. Software running on the portable device can provide users with the ability to order and/or purchase nail wraps that they have created. A user may have nail wraps delivered from a nail wrap provider to their home or place of business, or they may have their nail wraps sent directly to a salon. The electronic device may implement augmented reality to show a user how their nail wraps will appear when applied.

### CROSS REFERENCE TO RELATED APPLICATIONS

This application claims priority from U.S. Provisional Patent Application No. 62/008,834, filed Jun. 6, 2014, and entitled “Designing Nail Wraps with an Electronic Device,” which is expressly incorporated by reference herein in its entirety.

### TECHNICAL FIELD

The present technology pertains to applications for creating images with an electronic device, and more specifically to systems for facilitating the modification of images such that the images are suitable for converting into nail wraps.

### BACKGROUND

Nail wraps are a type of nail decoration used as an alternative to polish. Nail wraps are commonly made of various materials such as plastic or vinyl, and have a design or gloss finish. Nail wraps may be self-adhesive, and can last several weeks on fingernails and toenails. Additionally, nail wraps can be applied in the comfort of a user's home, or at a salon.

Nail wraps come in a variety of colors and designs. Customers typically choose pre-designed nail wraps which may include shapes and bright colors. However, customers typically do not have the ability to create their own designs.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer readable storage media for implementing applications that allow a user to edit an image stored on an electronic device to create nail wraps.

As portable device technology advances, along with advances in nail wrap technology, a need is created for users to seamlessly use their electronic devices to create nail wraps. In embodiments described herein, portable devices are able to capture images and provide the functionality for editing, scaling and/or cropping images such that a modified image is suitable to be reproduced on a nail wrap. In addition, embodiments described herein provide users with the ability to order and/or purchase nail wraps that they have created. A user may have nail wraps delivered from a nail wrap provider to their home or place of business, or they may have their nail wraps sent directly to a salon. Moreover, in embodiments described herein, an electronic device may implement augmented reality to show a user how their nail wraps will appear when applied.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary electronic environment in which methods and systems described herein can be executed;

FIG. 2 illustrates an exemplary interface of an application which may execute on an electronic device;

FIGS. 3A, 3B, and 3C illustrate exemplary embodiments of an electronic device displaying an interface that allows a user to create nail wraps;

FIG. 4 illustrates an exemplary embodiment of a user interface prompting a user to select a template;

FIG. 5 illustrates an exemplary embodiment of a user interface displaying nails;

FIG. 6 illustrates an exemplary embodiment of implementing augmented reality with a nail wrap application;

FIG. 7 illustrates an exemplary embodiment of implementing augmented reality with a nail wrap application;

FIG. 8 illustrates an exemplary embodiment of implementing augmented reality with a nail wrap application; and

FIGS. 9A and 9B illustrate exemplary electronic environments, in accordance with various embodiments.

### DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure.

Methods and systems described herein allow users to design nail wraps using an electronic device. In embodiments described herein, a user may capture an image with their phone, and edit the captured image so that the image is capable of being reproduced on a nail wrap. Once a design is created, the electronic device may send the image to a management system and/or a provider of nail wraps. The provider of nail wraps may send the nail wraps to a user's home or directly to a salon. While nail wraps shown in the accompanying drawings may be shown as round, substantially symmetric shapes, it should be understood that nail wraps may have tabs or other features connected to them for easy removal from a self-adhesive backing Nail wraps may be made from thin products such as paper, silk, linen, fiberglass, mesh, or other fabrics for reinforcement. Nail wraps may be embedded with gels and/or acrylics as a natural nail coating or extension and sealed with resin. Thus, nail wraps may be used to give the appearance of having a longer nail (e.g., a nail wrap that causes the free edge of the nail plate to appear to extend further from the nail bed than it actually does).

As used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software. In some embodiments, an action performed by a user may include accessing a mobile application.

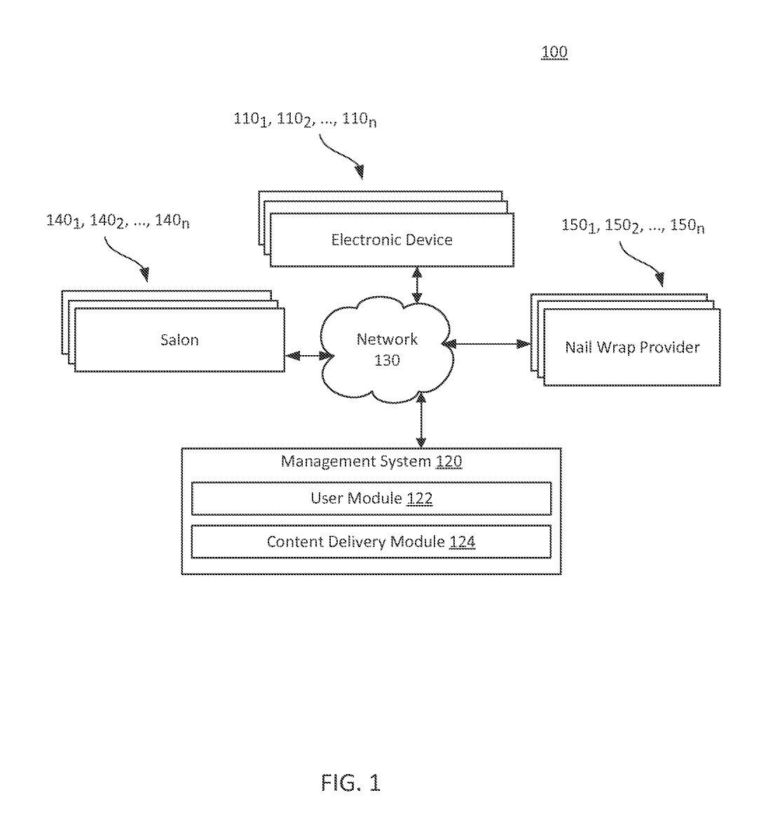

FIG. 1 illustrates an example electronic environment 100 in which methods and systems discussed herein can be executed. One or more electronic devices 110₁, 110₂, . . . 110ₙ (collectively “110”) may create an image to be reproduced on a nail wrap. Electronic device 110 may be one of a variety of devices, including, but not limited to: a smart phone, a digital camera, a wearable computer, a laptop computer, a desktop computer, etc. In some embodiments, electronic device 110 communicates with a management system 120 via network 130. For example, electronic device 110 may connect with management system 120 to sign into an account using user module 122. User module 122 may store previous nail wraps that a particular user has viewed. In some embodiments, user module 122 may allow a user to view designs that their friends and/or social connections have created.

Similarly, user module 122 may recommend particular nail wraps for a user. The recommendations may be based on nail wraps that are popular with other users. They may be based on trending nail wrap designs (e.g., the top selling design in the last week). In some embodiments, a sponsor may pay for a particular nail design to be provided to a user. For example, in response to a sponsor paying for advertising, nail wraps may be recommended to a user that include the sponsor's logo. In some embodiments, nail wraps created as part of a sponsorship campaign may be provided to users free of charge. For example, in response to one or more nail wraps including an advertisement or other type of content related to a brand, a user may be able to order the nail wraps free of charge. In such a case, the sponsor receives advertising by the user wearing the nails, the nail wrap company receives compensation from the sponsor, and the user receives a free set of nail wraps. In some embodiments, a user may receive a free set of nail wraps if they share information on a social network. For instance, a user may receive a gift or a free set of nail wraps if they post information associated with nail wraps to a social networking website. In some embodiments, a user's connections may want the design created by the user. In such a case, an application executing on an electronic device 110 may provide the functionality to allow a user's network buy the nail wraps created by the user. Moreover, in some embodiments, an application may allow a user to create a second set of nail wraps of a different size with the same design. For instance, on mother's day a user may wish to order a set of nail wraps for an adult and a matching set for one or more children.

Management system 120 may also include content delivery module 124. Content delivery module 124 may transmit information about a customer's nail wrap to one or more salons 140₁, 140₂, . . . 140ₙ (collectively “140”) and/or one or more nail wrap providers 150₁, 150₂, . . . 150ₙ (collectively “150”). A salon 140 may be anywhere that professionals apply nail wraps. A nail wrap provider 150 may be a manufacturer or distributor of nail wraps.

Typically, the quality of the application of a nail wrap is higher when applied at a salon 140. Thus, in particular embodiments, users may have their ordered nail wraps sent to a salon 140. In some embodiments, an application executing on an electronic device 110 may provide a user with a list of salons that participate in such a program (i.e., where a salon 140 receives nail wraps designed by a user of an electronic device 110 and then applies the nail wraps at the salon 140). An application executing on an electronic device 110 may allow a user to schedule an appointment with a particular salon 140. Further, various salons 140 may be rated by users based on the quality of their application of nail wraps. In some embodiments, a nail wrap provider 150 may receive a percentage of the money spent at a salon (e.g., a percentage of the amount spent on nail wraps or on a manicure). In some embodiments, an application executing on an electronic device 110 may automatically determine an amount of money to provide to a salon 140 and/or an amount of money to provide to a nail wrap provider 150.

In some embodiments, a salon 140 may comprise electronic devices for a user to create their own designs for nail wraps while at the salon 140. For instance, an electronic device 110 may be attached or otherwise connected to furniture near a chair where a user receives a manicure. This allows the user to order additional nail wraps and/or schedule additional salon appointments while they are having their nail wraps applied.

In some embodiments, in response to a user ordering nail wraps to be applied and/or delivered by a distributor to a salon, a user may receive a discount on their nail wraps, the application of the nail wraps, or other items or services. In some embodiments, the design portion of the process (e.g., designing nail wraps and applying them at a salon) may be free in response to a user choosing the option to have the nail wraps applied at a salon. For example, a user may pay within an application for a manicure at a particular salon. In some embodiments, various salons that apply nail wraps are identified by an application. For example, a map may be displayed that indicates the location of salons that apply nail wraps. In some embodiments, the electronic devices may indicate which salons accept the delivery of nail wraps designed by a user using electronic devices described herein. In response to choosing to get the nail wraps professionally applied in a salon (which may be in a business relationship, such as a partnership with a nail wrap provider and/or nail wrap application provider), the user will receive the nail wraps created in the application for free. The user may then pay for a professional manicure within the application. Subsequent to a payment being made, a nail wrap provider and/or nail wrap application provider may receive a percentage of the costs or profits from a manicure from a salon which may be a partner. A user may receive a free or discounted nail wrap to be professionally applied in a partner salon. The complete process will be facilitated seamlessly within the app. Additionally, a user may pay for their nail wraps, pay for services or items at a salon, etc. with the application. In some embodiments, a user may be charged a percentage of a transaction may be provided to the owner and/or operator of the embodiments described herein. For example, when purchasing nail wraps or booking an appointment at a salon, an application may indicate an amount that the user is paying to an entity associated with (e.g., owns, licenses, etc.) the nail wrap application as described in various embodiments herein.

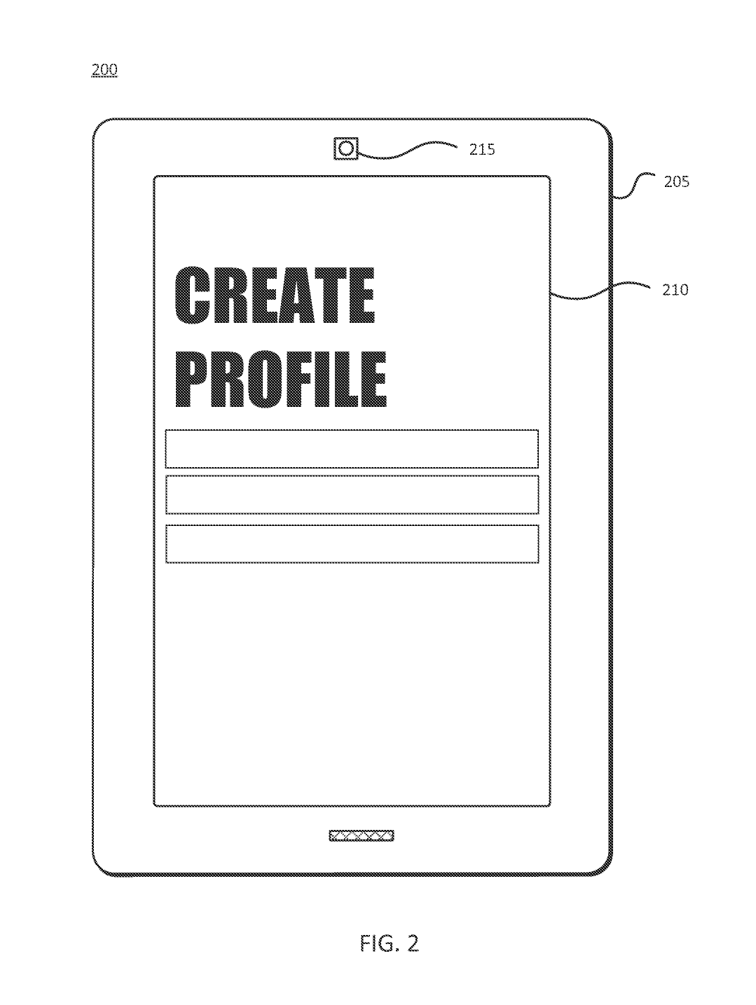

FIG. 2 illustrates an exemplary environment 200 of an electronic device 205 displaying an interface of an application 210 that allows a user to create nail wraps. Of course, electronic device 205 may have a camera 215 and other input/output devices. In example environment 200, a user is prompted to create a profile. As described above, the profile may be created using management system 120.

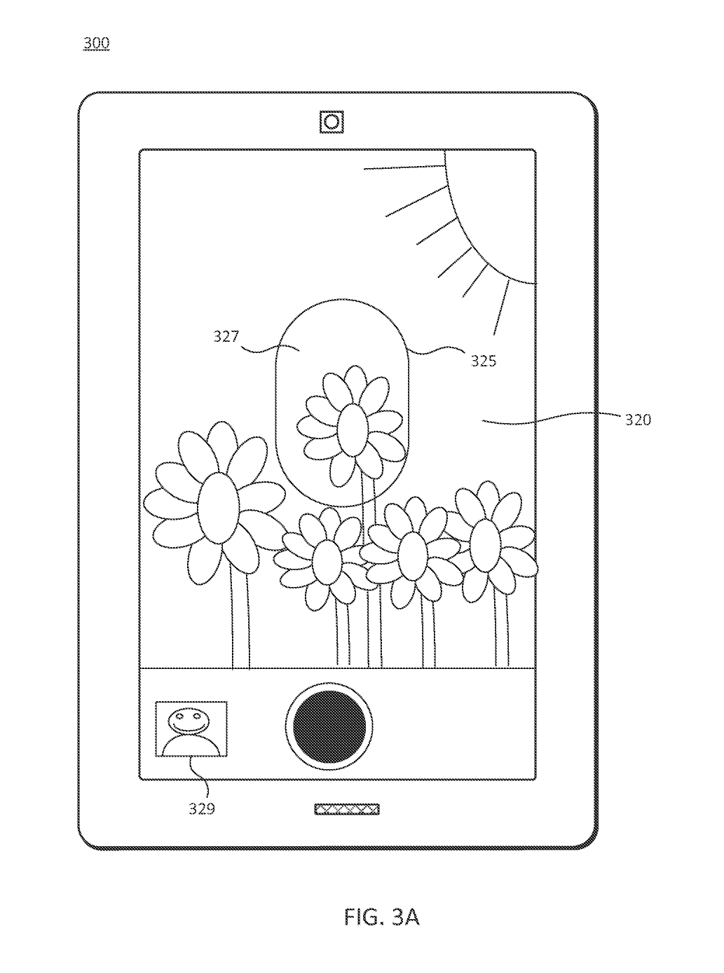

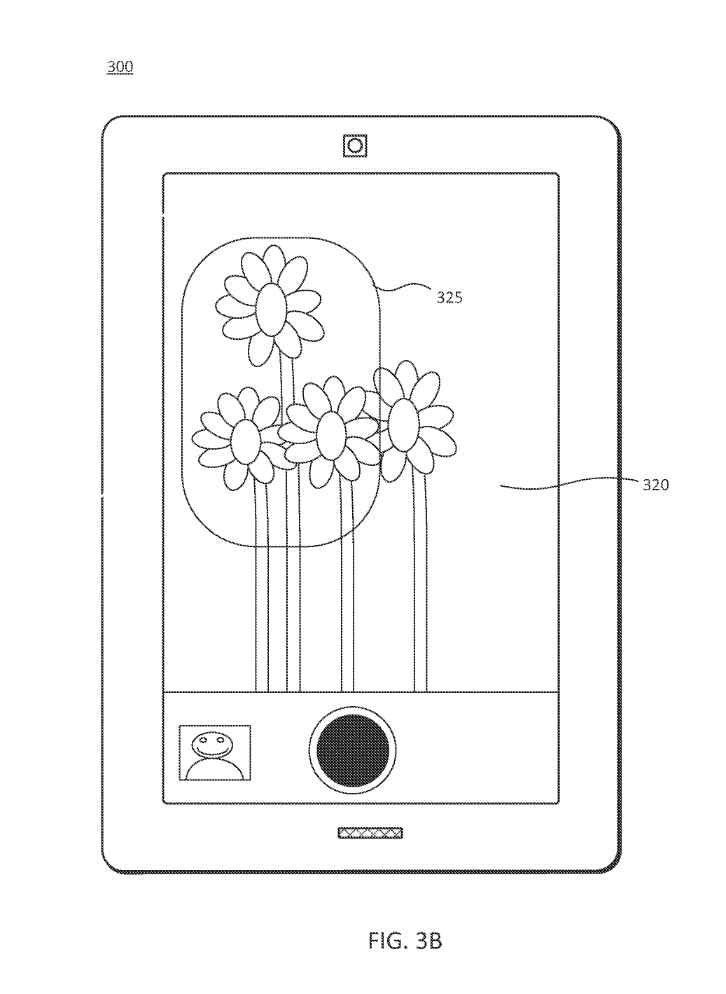

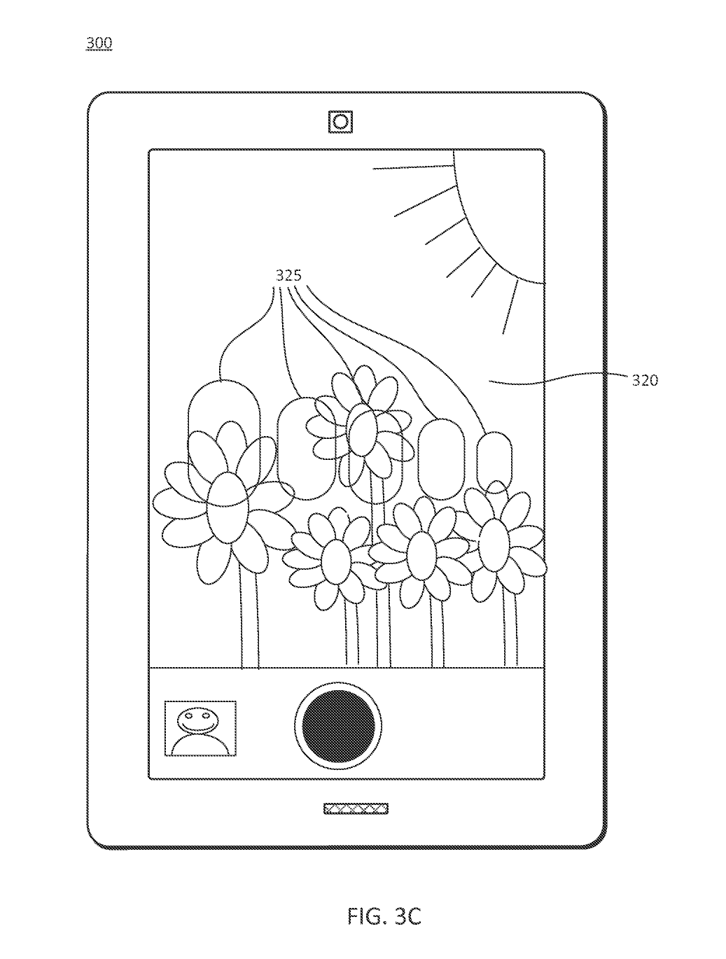

FIG. 3A illustrates an exemplary environment 300 of an electronic device 205 displaying an interface of an application 210 that allows a user to create nail wraps by capturing an image. It should be understood that an image previously stored on the device may also be used. For example, a previously stored image may be selected by clicking on an icon representing a user's photo album 329. In the example shown in FIG. 3A, application 210 shows an image being captured by a camera, and an outline of a nail 325 such that a user may preview how an image may be cropped and/or masked in order to create a nail wrap. In some embodiments, an outline of a nail 325 may simply be a line in the shape of a nail overlaying a background image 320. In some embodiments, the outline of the nail 325 may be used to mask the background image 320, such that only the area within an outline of a nail 327 is visible.

In various embodiments, a user may change the shape of the outline of the nail 325. For example, an application 210 may have settings that allow a user to change the shape of an outline of a nail 325 based on metadata associated with a user's profile. As another example, the shape of the nail outline may be based on a particular finger (e.g., the thumb or the index finger may have different shapes). In some embodiments, a user may manually change the shape of an outline of a nail 325 by manipulating widgets such as buttons or slide bars. In some embodiments the shape of the mask may be chosen from a set of masks provided by the application 210.

FIG. 3B illustrates an exemplary environment 300 of an electronic device 205 displaying an interface of an application 210 that allows a user to create nail wraps. In some embodiments, application 210 allows a user to move an outline of a nail 325 such that the user can obtain a desired image for their nail wrap. For example, application 210 may allow a user to zoom in and out when capturing an image. Application 210 may allow a user to move an outline of a nail 325 in different positions on the display of the background image. For instance, in FIG. 3B the nail outline is shown in the upper-left of the display.

In some embodiments, a captured and/or stored image may be scaled to a particular shape and size. For example, in some embodiments, the application allows a user to make the background image 320 larger or smaller while the size of the nail outline 325 remains static. In some embodiments this occurs automatically. In some embodiments, after an image is taken, a point of interest within the image may automatically be centered and scaled such that it fits within an outline of a nail 325. In some embodiments, the application 210 is configured such that a portion of the image within an outline of a nail 325 will be replicated on every nail wrap. For example, an image of three flowers as shown within the outline of a nail 325 in FIG. 3B may be reproduced on each nail wrap (e.g., 5, 10, 13 or 26 nail wraps). In some embodiments different images may appear within a set of nail wraps.

As described herein, in various embodiments images may be scaled and/or cropped for each individual nail wrap. The cropping and the scaling function relates to the size of a picture to be placed on each nail, e.g. the size of an image can be adjusted for each nail. The images can also be rotated 360 degrees until the user is satisfied with the look of the image on the nail. The cropping and scaling function gives the user virtually limitless options to size and rotate the picture on the nail template. For instance, a user may choose each nail individually and decorate it as they wish. In some embodiments, all of the nail wraps must use at least a portion of the same image. The nail wraps may be scaled to different sizes using various portions of the same image. In some embodiments, one or more nail wraps may employ different images. For instance, a user may take many pictures, and place each picture on a different nail wrap. A user could take pictures of ten, thirteen, or twenty-six of their friends, and place a different friend on each nail wrap.

FIG. 3C illustrates an exemplary environment 300 of an electronic device 205 displaying an interface of an application 210 that allows a user to create nail wraps with different images. In this example, multiple outlines of nails 325 are shown. This may allow a user to create different images on each nail, where the image on each nail is originally from a single image 320. It should be understood that a user may modify the shape and position of some or all of the nail outlines 225. Similarly, a user may adjust the scale of a background image 320. In some embodiments, a user may add or remove outlines of nails 325. For example, there could be five (5) outlines of nails, or there could be ten (10), thirteen (13), or twenty-six (26) outlines of nails. In some embodiments either thirteen or twenty-six nails may be shown since nail wraps are typically ordered in packs of twenty-six (thirteen per row of nails).

An advantage of the example embodiments in FIG. 3C is that users may create numerous images from a single photo. In some embodiments, the image and/or the outlines of nails 325 can be modified. For example, if a user wanted to create a set of nails that resemble the Hollywood sign in Los Angeles, a user may take an image of the sign with an electronic device 205 and then scale or otherwise modify the image and/or outlines of nails 325 until the desired portions of the Hollywood sign are within the outlines of nails 325. In some embodiments, the multiple outlines of nails 325 may be static, such that a user must create nail wraps given outlines of nails 325 with a pre-determined position and/or size. It should be understood that although only five outlines of nails 325 are shown in the figure, more or less may be present (e.g., 10, 13, 26, etc.).

In some embodiments, application 210 may notify users of various points of interest. For example, an application 210 may include a map, or otherwise list locations where users tend to capture images. For example, application 210 may notify a user that many people capture images of the Golden Gate Bridge and convert the captured images into nail wraps. While the Golden Gate Bridge is a world famous landmark, application 210 may also notify a user of points of interest that are less well known, or that users find to be more suitable for converting into nail wraps. For instance, application 210 may indicate that many users enjoy taking images of a city's skyline and converting buildings within those images into nail wraps. In some embodiments, a particular piece of art, landmark, or other point of interest where a user is more likely to capture images for creating nail wraps than capturing ordinary photos are provided to a user of application 210. For instance, an application 210 may store how many images are captured, where those images are captured, and provide a user with statistics, such as areas where a high number of images were captured and subsequently converted into nail wraps. It is contemplated that in some embodiments, an electronic device 205 may comprise a global positioning system or some other type of location recognition module such that management system 120, a nail provider 150, a salon 140, or another user may view when and where one or more images were captured.

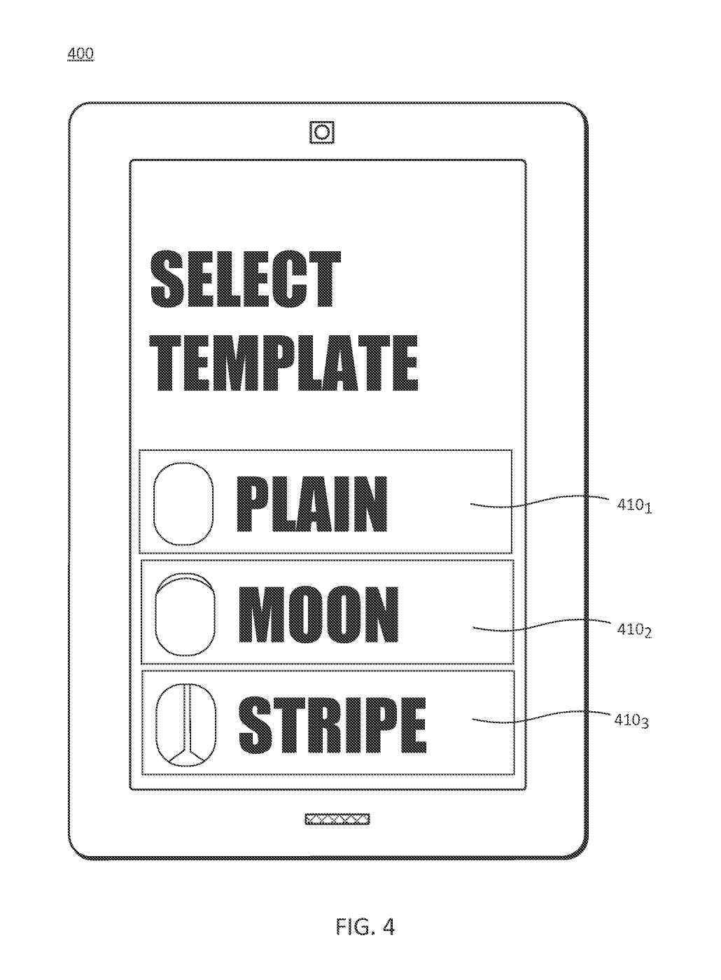

FIG. 4 illustrates an example electronic environment 400 where application 210 provides a user with the option to choose a template 410₁, 410₂, 410₃ (collectively “410”) to place on a nail wrap. In some embodiments, a template may appear as though it were included in a nail outline 325 (e.g., the template may appear while a user is capturing an image as a mask).

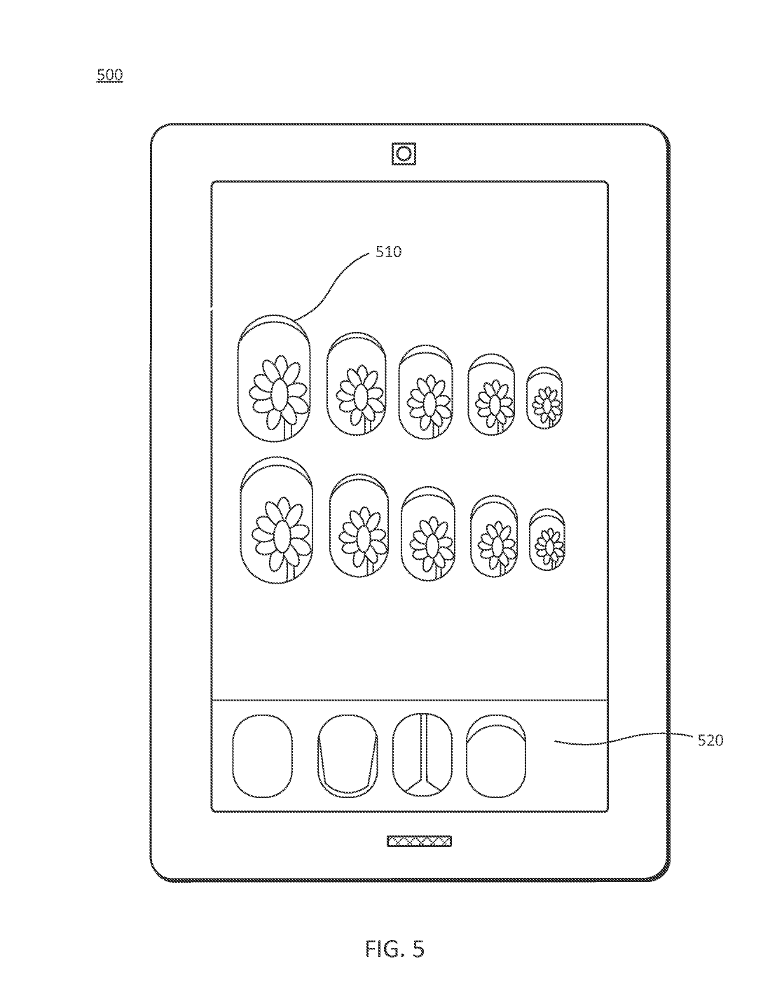

FIG. 5 similarly illustrates an example environment 500 where application 210 provides a user with the ability to preview a nail wrap with a template 510. Templates may also be referred to as decorations. Various templates are available to a user. In some embodiments, various templates 520 may be selected for a user to preview on a nail wrap they may have started designing. It is contemplated that many templates and types of nail wraps are available to users, including, but not limited to: half-moons, one or more horizontal lines, one or more vertical lines, stripes, orbit shaped templates, triangles (e.g., that come out of bottom of nail wrap upward), hearts, stars, gradients, crowns, polka dots, chevrons, bows, lips, leopard print, lace print, holiday symbols (e.g., symbols corresponding with Valentine's Day, Halloween, Christmas, etc.), colors associated with a season of the year, letters, a name, anchors, skulls, paint splatters, mustaches, astrological symbols, palm trees, music notes, etc. In some embodiments, the templates may be scaled, cropped, placed in different positions on a nail wrap or otherwise modified, on some or all nail wraps. Some templates may be at least partially transparent. Some templates may add or remove color from an image such as a sepia or black and white filter. In some embodiments other filters may be available to change the tone of an image which may blur, darken, brighten, or otherwise add a lighting effect to an image. In some embodiments, templates may include brand logos, cartoon characters, etc. Further, nail wraps may include sets of templates. For example, a Christmas pack of nail wrap templates may include one nail wrap with a Christmas tree, another nail wrap with a snowflake, etc. It should be understood that templates may be configured to be any color or combination of colors, and may have varying levels of transparency. For example, some templates may consist of a red line in a moon shape across the top of a nail, while other templates may include a multi-colored symbol.

Moreover, it should be understood that although ten nails are shown, FIG. 5 is merely an example. In some embodiments, thirteen or twenty six nails may be shown. In addition, embodiments described herein may be used for toenails as well as fingernails.

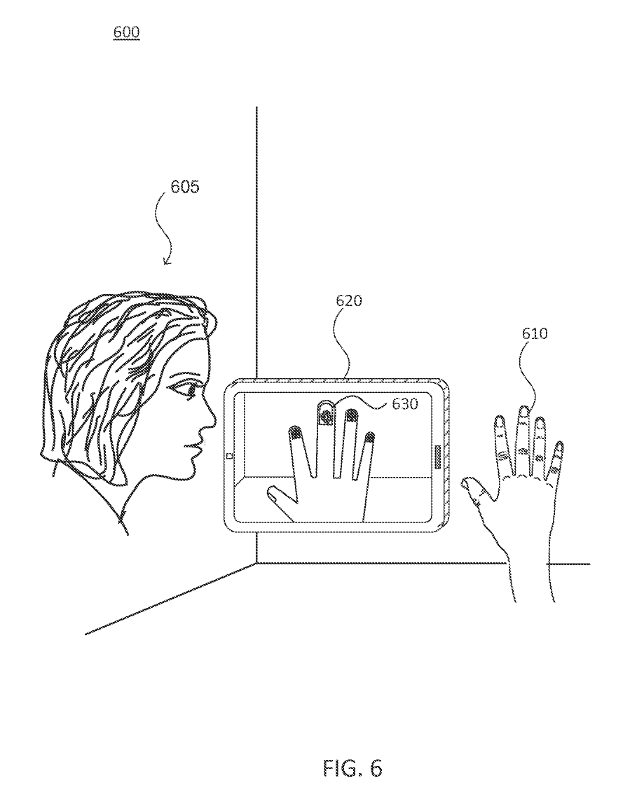

FIG. 6 illustrates an environment 600 including an exemplary embodiment of implementing augmented reality with a nail wrap application. In some embodiments described herein, a user may preview what their hand will look like with a particular nail wrap using augmented reality. For example, as shown in environment 600, user 605 is able to view their hand 610 using an electronic device 620. The electronic device captures images and/or video of at least one finger and/or hand 610 and displays a corresponding image on the electronic device where virtual nail wraps 630 are overlaid on a user's nails. In some embodiments, a user is able to choose favorite nail wraps, or otherwise mark nail wrap designs such that they can easily select them for viewing using augmented reality. That way, a user does not have to return to a nail design screen every time the user would like to view a different nail design. Similarly, in some embodiments a link may be correspond with a set of nails and when selected, the link may cause the electronic device to switch to an augmented reality mode such that a user can preview the nails that the user was browsing.

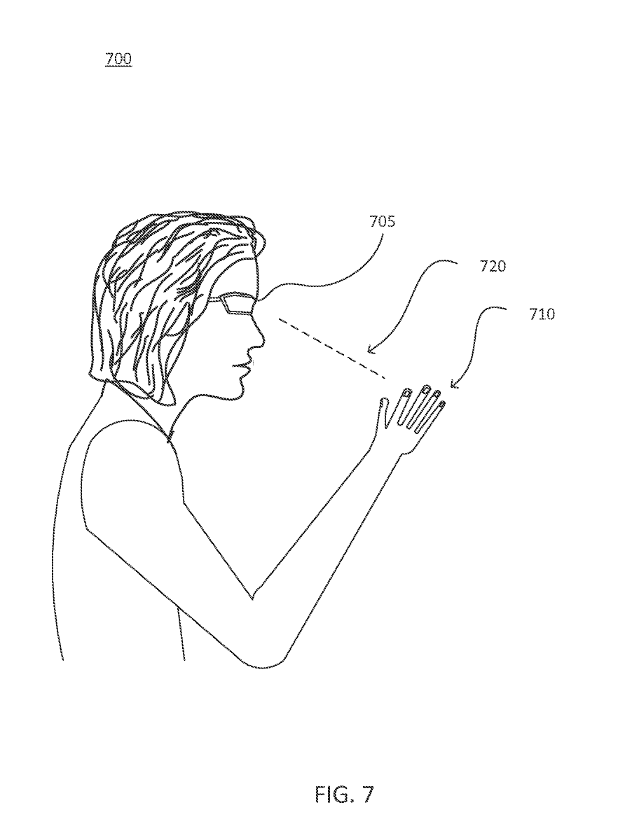

FIG. 7 illustrates an environment 700 including an exemplary embodiment of implementing augmented reality with a nail wrap application and a wearable computer 705. In some embodiments, an electronic device may be a wearable computer 705 such as glasses or a watch. In such embodiments, users may capture images of their hands and/or finger nails 710, via line of sight 720, using a camera coupled with wearable computer 705 such that they may preview what their nails may look like with a particular nail wrap design on a display screen included in the wearable computer. Various voice commands may be accepted by wearable computer 705 allowing a user to switch between preview designs, select templates, capture images, etc.

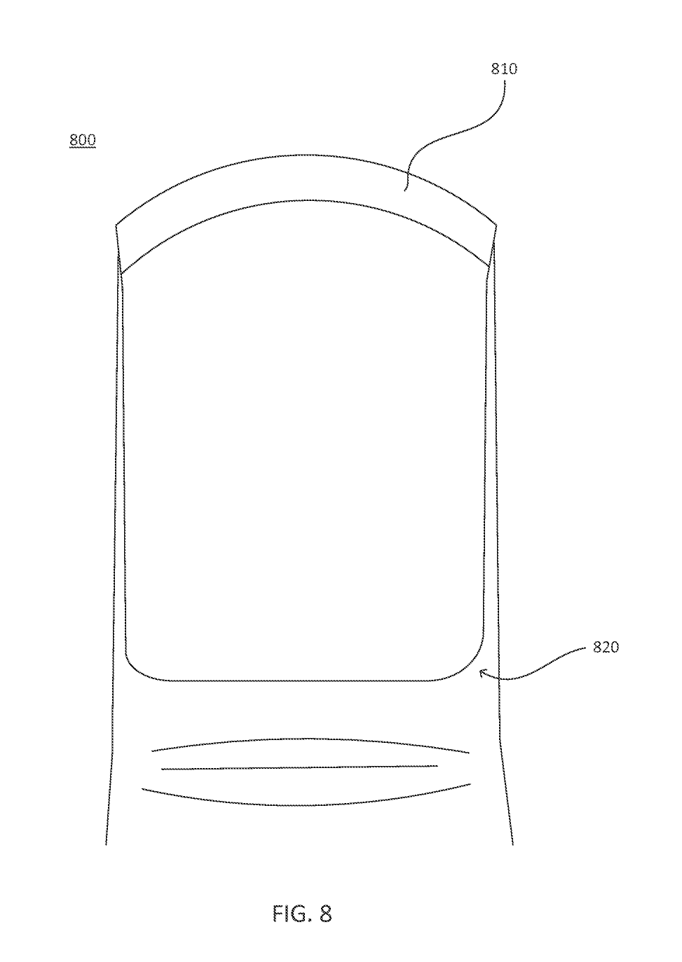

FIG. 8 illustrates an example finger 800 used to implement augmented reality with a nail wrap application. In various embodiments, portions of a finger 800 may be used as a fiducial marker to assist with an augmented reality system. For example, in order to correctly overlay a preview of a nail wrap using an augmented reality system, the system must be able to recognize a location where a nail wrap should be placed. In some embodiments, a marker such as a green dot on each fingernail may be used. In some embodiments, portions of a finger may be used as a marker. For instance, an augmented reality system may use a portion of a fingernail that is expected to be lighter than other portions of a fingernail as a marker. For example, an augmented system could use the tip of the nail 810 (also known as the distal free edge of a nail) as a marker. In some embodiments, an area where the nail meets the skin 820 may be used as a marker. For instance, the bottom of a nail may be determined by comparing the colors/shades between a nail and the skin surrounding the nail (e.g., a cuticle, a side or proximal nail fold, the skin adjacent to a side or proximal nail fold and/or cuticle). In some embodiments, if a particular threshold difference in color between a nail and skin surrounding the nail is met, an augmented reality system/application will determine that the bottom of the nail has been found. In such a case, the bottom of the nail may be used as a fiducial marker (here, bottom refers to an area substantially close to the proximal nail fold). In some embodiments, the overlaid virtual nail wrap will not extend beyond the determined proximal nail fold when a user is previewing the nail wrap on their nails via augmented reality.

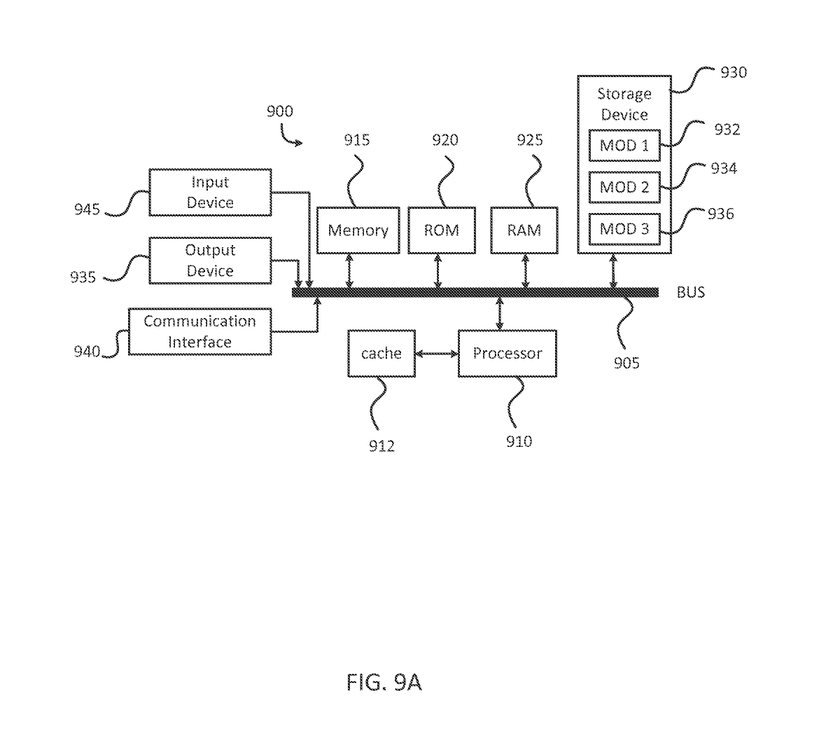

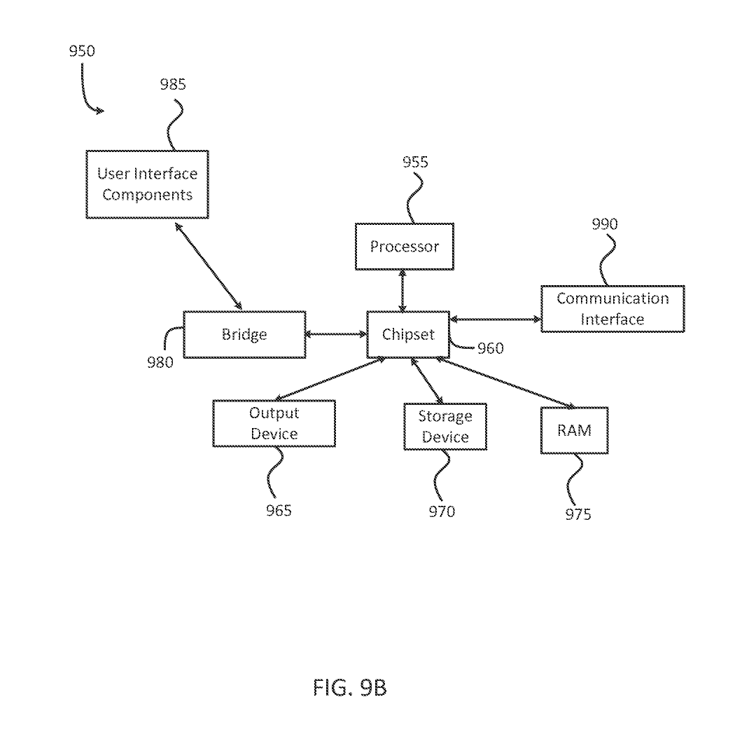

FIG. 9A, and FIG. 9B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 920 and random access memory (RAM) 925, to the processor 910. The system 900 can include a cache of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 932, module 2 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software modules 932, 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates a computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that exemplary systems 900 and 950 can have more than one processor 910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, tablets, smart phones, wearable computers, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer implemented method comprising:
displaying an image on a display;
representing a nail region on the image; and
creating a nail wrap design comprising a portion of the image within the nail region.

2. The method of claim 1 further comprising:
displaying a map of locations where users have captured images that were used to create nail wrap designs.

3. The method of claim 1, further comprising representing an additional nail region on the image.

4. The method of claim 1, wherein representing the nail region further comprises:
displaying a mask over the region surrounding the nail region.

5. The method of claim 1, further comprising altering the nail region according to input received to alter the nail region.

6. The method of claim 1, further comprising altering the image according to input received to alter the image.

7. The method of claiml, further comprising receiving an input indicating a user wishes to purchase a nail wrap based on the nail wrap design.

8. The method of claiml, further comprising:
displaying a list of salons that can apply the nail wrap designs onto fingernails;
receiving a selection of a salon; and
sending information about the nail wrap design to the selected salon.

9. The method of claim 8 further comprising sending a scheduling request for the selected salon.

10. The method of claim 1, further comprising:
displaying a fingernail on a display;
scaling the nail wrap design to conform to the size of the fingernail; and
overlaying the scaled nail wrap design on the fingernail.

11. The method of claim 10, further comprising modifying the nail wrap design to conform to the orientation of the fingernail.

12. The method of claim 10, further comprising determining the outline of the nail.

13. The method of claim 10, further comprising:
detecting a voice command to modify the nail wrap design; and
modifying the nail wrap design.

14. A system comprising:
a processor;
a display configured to display an image and a representation of a nail on the image; and
a non-transitory computer-readable medium including computer readable instruction stored thereon, the instructions effective to cause the processor to:
create a nail wrap design comprising a portion of the image within the nail region.

15. The system of claim 14, further comprising a camera, wherein the instructions are further effective to cause the processor to:
capture an image of a fingernail with the camera;
display the image of the fingernail on the display;
scale the nail wrap design to conform with the size of the fingernail; and
overlay the scaled nail wrap design on the image of the fingernail.

16. The system of claim 15, further comprising a microphone, wherein the instructions are further effective to cause the processor to:
detect a voice command to modify the nail wrap design; and
modify the nail wrap design.

17. The system of claim 15, wherein the instructions are further effective to cause the processor to:
receive an input indicating a user wishes to purchase a nail wrap based on the nail wrap design.

18. The system of claim 15, wherein the instructions are further effective to cause the processor to:
display a list of salons that can apply the nail wrap designs onto fingernails;
receive a selection of a salon; and
send information about the nail wrap design to the selected salon.

19. The method of claim 15, wherein the instructions are further effective to cause the processor to display, on the display, a map of locations where users have captured images that were used to create nail wrap designs.

20. A non-transitory computer-readable medium comprising computer readable instructions stored thereon, the instructions when executed by a processor of a computing device cause the computing device to:
display an image on a display;
represent a nail region on the image;
create a nail wrap design comprising a portion of the image within the nail region.
capture an image of a fingernail with a camera;
display the image of the fingernail on the display;
scale the nail wrap design to conform with the size of the fingernail; and
overlay the scaled nail wrap design on the image of the fingernail.
